(19) United States
(12) Patent Application Publication
(10) Pub. No.: US 2026/0072397 A1
(43) Pub. Date: Mar. 12, 2026

(54) IMAGE FORMING APPARATUS

(71) Applicant: CANON KABUSHIKI KAISHA, Tokyo (JP)

(72) Inventors: JIRO YAMADA, Kanagawa (JP); TAKEO KAWANAMI, Kanagawa (JP); NORITOMO YAMAGUCHI, Kanagawa (JP); SHUN YAMASHITA, Shizuoka (JP)

(21) Appl. No.: 19/308,612

(22) Filed: Aug. 25, 2025

(30) Foreign Application Priority Data
Sep. 9, 2024 (JP) 2024-155381

(51) Int. Cl. G03G 21/18

(52) U.S. Cl. CPC G03G 21/1857; G03G 21/1814; G03G 2221/1606; G03G 2221/163; G03G 2221/1657

(57) ABSTRACT

An image forming apparatus includes a driving source, a first driven member, a second driven member, a first driving-force transmission unit configured to transmit driving force output from the driving source to the first driven member, the first driving-force transmission unit including a clutch mechanism, and a second driving-force transmission unit configured to transmit the driving force to the second driven member, the second driving-force transmission unit including a brake portion. The second driving-force transmission unit is connected to the first driving-force transmission unit between the clutch mechanism and the first driven member. In a case where the clutch mechanism is in the transmission state, the first driven member is driven by both of a first torque transmitted via the first driving-force transmission unit, and a second torque transmitted via the brake portion of the second driving-force transmission unit.

### BACKGROUND

### Field of the Technology

The present disclosure relates to an image forming apparatus that forms images on recording materials.

### Description of the Related Art

Japanese Patent Application Publication No. 2018-112661 proposes an image forming apparatus that includes a photosensitive drum and a developing roller that can be driven by a single motor. In a driving-force transmission path between the motor and the developing roller, a clutch apparatus is disposed. The state of the clutch apparatus can be switched between a transmission state where the clutch apparatus transmits the rotational drive from the motor, and a non-transmission state where the clutch apparatus does not transmit the rotational drive from the motor.

However, in the image forming apparatus described in Japanese Patent Application Publication No. 2018-112661, when the state of the clutch apparatus is switched from the transmission state to the non-transmission state, the torque applied to the developing roller instantaneously becomes zero, causing larger change in the torque. Thus, when the state of the clutch apparatus is switched from the transmission state to the non-transmission state, a larger impact is caused.

### SUMMARY

According to one aspect of the present disclosure, an image forming apparatus configured to form an image on a recording material includes a driving source, a first driven member, a second driven member different from the first driven member, a first driving-force transmission unit configured to transmit driving force output from the driving source to the first driven member, the first driving-force transmission unit including a clutch mechanism configured to be switched between a transmission state and a non-transmission state, the transmission state being a state where the driving force output from the driving source is transmitted to the first driven member, the non-transmission state being a state where the driving force output from the driving source is not transmitted to the first driven member, and a second driving-force transmission unit configured to transmit the driving force output from the driving source to the second driven member, and connected to the first driving-force transmission unit, the second driving-force transmission unit including a brake portion configured to produce brake force to apply load to rotation of the second driven member. The second driving-force transmission unit is connected to the first driving-force transmission unit between the clutch mechanism and the first driven member. In a case where the clutch mechanism is in the transmission state, the first driven member is driven by both of a first torque transmitted via the first driving-force transmission unit, and a second torque transmitted via the brake portion of the second driving-force transmission unit.

Features of the present disclosure will become apparent from the following description of embodiments with reference to the attached drawings. The following description of embodiments is described by way of example.

### BRIEF DESCRIPTION OF THE DRAWINGS

FIG. 1 is an overall schematic diagram illustrating a printer of the present embodiment.

FIG. 2 is a schematic diagram illustrating the printer in a state where a door is opened.

FIG. 3 is a perspective view illustrating a cartridge.

FIG. 4 is an enlarged perspective view illustrating a drum coupling.

FIG. 5 is a perspective view illustrating a driving-force transmission mechanism.

FIG. 6A is an exploded perspective view illustrating a clutch unit.

FIG. 6B is another exploded perspective view illustrating the clutch unit.

FIG. 7A is a cross-sectional view illustrating the clutch unit that is in a transmission state.

FIG. 7B is a cross-sectional view illustrating the clutch unit that is in a non-transmission state.

FIG. 8A is an exploded perspective view illustrating a second driving-force transmission unit.

FIG. 8B is an exploded perspective view illustrating a first brake-engagement member, a second brake-engagement member, and a brake transmission member.

FIG. 9 is a cross-sectional view illustrating the second driving-force transmission unit.

FIG. 10A is a perspective view illustrating a drum driving coupling.

FIG. 10B is a perspective view illustrating the drum driving coupling and a coupling engagement portion.

FIG. 10C is a perspective view illustrating a state where the coupling engagement portion rotates in a through-hole.

FIG. 11 is a cross-sectional view illustrating a state where the drum driving coupling and the drum coupling are engaged with each other.

FIG. 12 is an enlarged cross-sectional view illustrating a vicinity of a projection portion of the drum coupling.

FIG. 13A is a schematic diagram illustrating a driving-force transmission path along which the driving-force is transmitted from a motor to a developing coupling in a case where the clutch unit is in a transmission state.

FIG. 13B is a schematic diagram illustrating a driving-force transmission path along which the driving-force is transmitted from the motor to the developing coupling in a case where the clutch unit is in a non-transmission state.

FIG. 14A is a graph illustrating the torque applied to the developing coupling in a comparative example.

FIG. 14B is a graph illustrating the torque applied to the developing coupling in the present embodiment.

### DESCRIPTION OF THE EMBODIMENTS

### Overall Configuration

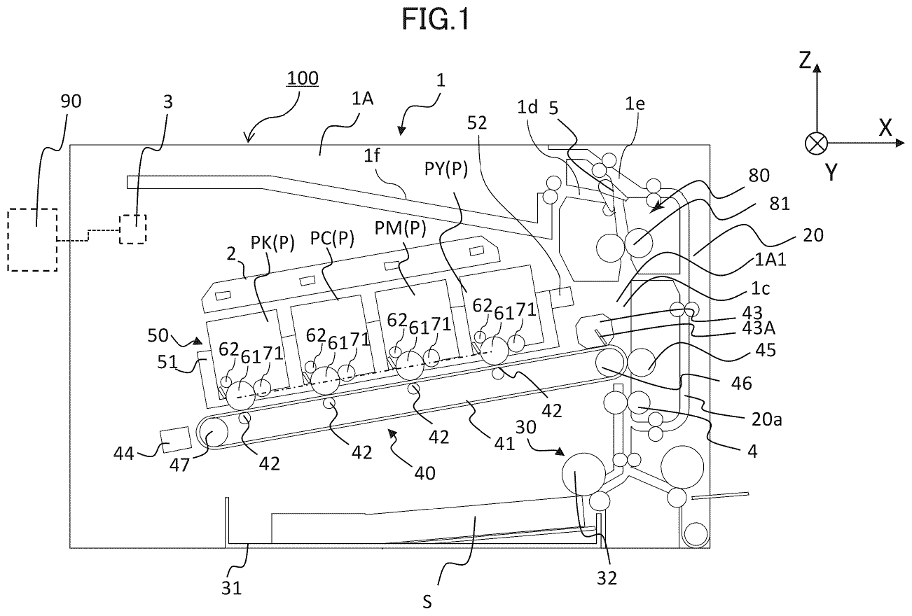

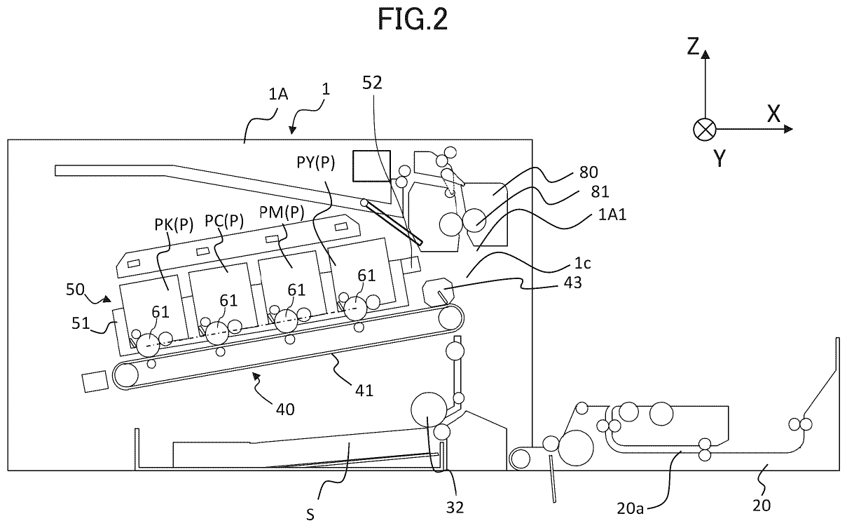

First, an overall configuration of a printer 1 that serves as an image forming apparatus of the present embodiment will be described with reference to FIGS. 1 and 2. FIG. 1 is a schematic diagram illustrating the overall configuration of the printer 1 of the present embodiment. FIG. 2 is a schematic diagram illustrating the printer 1 that is in a state where a door 20 is opened. The printer 1 is an electrophotographic color laser beam printer that forms an image on a sheet S that serves as a recording material.

In the following description and the drawings, a vertical direction in a case where the printer 1 is placed on a horizontal plane is defined as a Z-axis direction. The rotation-axis direction of a photosensitive drum 61 included in the printer 1 is defined as a Y-axis direction. In addition, a direction that intersects both of the Z-axis direction and the Y-axis direction is defined as an X-axis direction. Preferably, the X-axis direction, the Y-axis direction, and the Z-axis direction are orthogonal to each other. In addition, there is a case where one side of the X-axis direction (i.e., the side indicated by an X arrow) is referred to as a +X side or a +X direction, and where the other side of the X-axis direction is referred to as a −X side or a −X direction. Similarly, there is a case where one side of the Y-axis direction (i.e., the side indicated by a Y arrow) is referred to as a +Y side or a +Y direction, and where the other side of the Y-axis direction is referred to as a −Y side or a −Y direction. Furthermore, there is a case where one side of the Z-axis direction (i.e., the side indicated by a Z arrow) is referred to as a +Z side or a +Z direction, and where the other side of the Z-axis direction is referred to as a −Z side or a −Z direction.

The +X direction may be referred to as a front surface side (front side) of the printer 1. In addition, the +Y side viewed from the front surface side of the printer 1 may be referred to as a right side, and the −Y side viewed from the front surface side of the printer 1 may be referred to as a left side.

As illustrated in FIG. 1, the printer 1 includes an apparatus body (casing) 1A, a scanner 2, a control portion 3, and the door 20. In addition, the printer 1 includes a sheet feeding portion 30, a transfer unit 40, a tray unit (detachable unit) 50, and a fixing apparatus 80. A portion that includes the apparatus body 1A and the door 20 may be referred to as a mainframe 100 of the printer 1. The mainframe 100 includes an exterior portion of the printer 1. The apparatus body 1A accommodates the scanner 2, the control portion 3, the sheet feeding portion 30, the transfer unit 40, a secondary transfer roller 45, the tray unit 50, and the fixing apparatus 80.

The sheet feeding portion 30 includes a stacking tray 31 that stacks the sheet S, and a feeding roller 32 that feeds the sheet S. The stacking tray 31 can be drawn toward the door 20, and the sheet S can be supplied to the stacking tray 31. In the present embodiment, the opening direction of the door 20 and the drawing direction of the stacking tray 31 are the same as each other, and are the +X side.

The tray unit 50 includes a tray (support member, drawer) 51 and cartridges PY, PM, PC, and PK. The tray 51 includes a tray handle (holding portion) 52. The cartridges PY, PM, PC, and PK are detachably (removably) attached to the tray 51.

The cartridges PY, PM, PC, and PK can be detachably attached to the tray 51 independently of each other. The cartridges PY, PM, PC, and PK respectively contain toner (developer) of yellow (Y), magenta (M), cyan (C), and black (K). The cartridges PY, PM, PC, and PK have configurations identical to each other, except that the colors of toner contained in the cartridges are different from each other. Thus, the configuration and operation of any one of the cartridges PY, PM, PC, and PK will be described, and the description for the other cartridges may be omitted. In addition, in a case where the cartridges PY, PM, PC, and PK need not to be distinguished from each other, each of the cartridges PY, PM, PC, and PK may be simply referred to as a cartridge P. Thus, the tray unit 50, in other words, includes a plurality of cartridges P, and the tray 51 to which the plurality of cartridges P is detachably attached.

In the present embodiment, the tray unit 50 includes a plurality of photosensitive drums (image bearing members) 61, a plurality of charging rollers (charging members) 62, and a plurality of developing rollers (developing members, developer bearing members) 71. Specifically, the tray unit 50 includes four photosensitive drums 61, four charging rollers 62, and four developing rollers 71. The rotation-axis direction of each photosensitive drum 61, the rotation-axis direction of each developing roller 71, and the rotation-axis direction of each charging roller 62 are substantially parallel to each other.

A portion of the tray unit 50 that forms a black image can be called a black station (first station); and the photosensitive drum 61, the developing roller 71, and the charging roller 62 of the first station can respectively be called a first photosensitive drum, a first developing roller, and a first charging roller. A portion of the tray unit 50 that forms a cyan image can be called a cyan station (second station); and the photosensitive drum 61, the developing roller 71, and the charging roller 62 of the second station can respectively be called a second photosensitive drum, a second developing roller, and a second charging roller. A portion of the tray unit 50 that forms a magenta image can be called a magenta station (third station); and the photosensitive drum 61, the developing roller 71, and the charging roller 62 of the third station can respectively be called a third photosensitive drum, a third developing roller, and a third charging roller. A portion of the tray unit 50 that forms a yellow image can be called a yellow station (fourth station); and the photosensitive drum 61, the developing roller 71, and the charging roller 62 of the fourth station can respectively be called a fourth photosensitive drum, a fourth developing roller, and a fourth charging roller.

The cartridge PK attached to the tray 51 constitutes at least a portion of the black station. The cartridge PC attached to the tray 51 constitutes at least a portion of the cyan station. The cartridge PM attached to the tray 51 constitutes at least a portion of the magenta station. The cartridge PY attached to the tray 51 constitutes at least a portion of the yellow station. The cartridges PK, PC, PM, and PY may respectively be referred to as a first cartridge, a second cartridge, a third cartridge, and a fourth cartridge. Note that the ordinal numbers, such as first, second, third, and fourth, described above are used for convenience of description.

The photosensitive drum 61, the charging roller 62, and the developing roller 71 have only to be included in any one of the cartridge P and the tray 51. In the present embodiment, the cartridge P includes the photosensitive drum 61, the charging roller 62, and the developing roller 71.

The transfer unit 40 includes a belt 41, primary transfer rollers 42, a cleaning portion 43, a driving roller 46 that drives the belt 41, and a tension roller 47. In addition, in the printer 1, an optical sensor 44 that detects a toner image transferred to the belt 41 is disposed. In the present embodiment, the belt 41 is disposed below the photosensitive drum 61, and is in contact with the photosensitive drum 61 so that a primary transfer portion is formed between the belt 41 and the photosensitive drum 61.

In addition, the printer 1 includes the secondary transfer roller 45 that is in contact with the belt 41 so that a secondary transfer portion is formed. The secondary transfer portion is formed between the belt 41 and the secondary transfer roller 45. The rotation-axis direction of the primary transfer rollers 42, the rotation-axis direction of the driving roller 46, the rotation-axis direction of the tension roller 47, and the rotation-axis direction of the secondary transfer roller 45 are substantially parallel with each other. In addition, a registration roller pair 4 is disposed upstream of the secondary transfer portion in the conveyance direction of the sheet S.

The fixing apparatus 80 includes a fixing portion 81 and a switching guide 5. The fixing apparatus 80 of the present embodiment can move with respect to the apparatus body 1A, between a use position and a retracted position. In a case where an image forming operation is performed, the fixing apparatus 80 is in the use position. In a state where the fixing apparatus 80 is in the use position, the fixing apparatus 80 is accommodated in the interior (inside) of the apparatus body 1A. In addition, the fixing apparatus 80 heats the sheet S in a state where the fixing apparatus 80 is in the use position. The fixing portion 81 includes a heating portion (heating roller) that includes a heater (heat source), and a pressing portion (pressing roller) that, together with the heating portion, forms a fixing nip.

As illustrated in FIG. 2, the apparatus body 1A includes an opening 1A1 in an end portion on the +X side. The door 20 is an opening-and-closing member (cover member, front cover) that can move with respect to the apparatus body 1A, between a closed position and an open position. As illustrated in FIG. 1, in a state where the door 20 is in the closed position, the door 20 covers the opening 1A1. As illustrated in FIG. 2, in a state where the door 20 is in the open position, the opening 1A1 is exposed to the outside. In a state where the door 20 is in the closed position, the printer 1 performs the below-described image forming operation. In a state where the door 20 is in the open position, the tray unit 50 and the transfer unit 40 are allowed to be drawn from the apparatus body 1A through the opening 1A1. Note that the tray unit 50 can be drawn from the apparatus body 1A by a user pulling the tray handle 52 of the tray 51. In a state where the tray 51 is drawn from the apparatus body 1A, the cartridge P can be separated from the tray 51.

That is, the cartridge P can be regarded as a detachable unit that can be detached from the apparatus body 1A. In addition, the tray unit 50 can also be regarded as a detachable unit that can be detached from the apparatus body 1A. A below-described drum unit 68 disposed in the cartridge P is an example of a driven member that is rotatably disposed.

For allowing the opening 1A1 to be exposed widely, the fixing apparatus 80 can move (retract) from the use position illustrated in FIG. 1, to the retracted position retracted upward from the use position. In a state where the door 20 is moved to the open position and the fixing apparatus 80 is moved to the retracted position, the transfer unit 40 and the tray unit 50 can be moved from the inside to the outside of the apparatus body 1A through the opening 1A1.

### Image Forming Operation

Next, an image forming operation will be described with reference to FIG. 1. The image forming operation is a series of operations in which the printer 1 forms an image on the sheet S while conveying the sheet S. The control portion 3 of the printer 1 starts the image forming operation, based on the image information sent from an external host apparatus 90. For example, the external host apparatus 90 is a personal computer, an image reader, a facsimile, or the like.

If the image forming operation is started, the photosensitive drum 61 is driven and rotated, and the charging roller 21 applied with a charging voltage uniformly charges the surface of the photosensitive drum 61, in each station of the tray unit 50. In addition, a laser beam that corresponds to the image information is emitted from the scanner 2 to each photosensitive drum 61, so that the surface of the photosensitive drum 61 is exposed. With this exposure, an electrostatic latent image is formed on the surface of the photosensitive drum 61. The electrostatic latent image corresponds to an image obtained by decomposing the image information into a corresponding one of CMYK components.

The developing roller 71 rotates while bearing the toner. The developing roller 71 is applied with a developing voltage, and the electrostatic latent image formed on the photosensitive drum 61 is developed by the toner supplied from the developing roller 71. As a result, a toner image is formed on the surface of the photosensitive drum 61. In the present embodiment, the developing roller 71 develops the electrostatic latent image in a state where the developing roller 71 is in contact with the photosensitive drum 61 (contact developing system). However, another system may be used. For example, the developing roller 71 may develop the electrostatic latent image in a state where a clearance is formed between the developing roller 71 and the photosensitive drum 61. In a case where a full-color image is formed, a toner image of each color is formed on a corresponding photosensitive drum 61.

In the present embodiment, the developing roller 71 can move between an abutment position in which the developing roller 71 is in contact with the photosensitive drum 61, and a separation position in which the developing roller 71 is separated from the photosensitive drum 61. Specifically, the state where the developing roller 71 is positioned in the abutment position and the state where the developing roller 71 is positioned in the separation position is switched by a switching apparatus included in the apparatus body 1A. Thus, in a state where the image forming operation is not performed, the developing roller 71 can be separated from the photosensitive drum 61.

In addition, the printer 1 can perform monochrome printing in a state where the developing roller 71 and the photosensitive drum 61 of the cartridge PK are in contact with each other, and where the developing roller 71 and the photosensitive drum 61 of each of the cartridges PY, PM, and PC are not in contact with each other. In addition, the printer 1 can perform full-color printing in a state where the photosensitive drum 61 of each of the cartridges PY, PM, PC, and PK and the belt 41 are in contact with each other.

The toner image formed on each photosensitive drum 61 is transferred onto the belt 41 by a corresponding primary transfer roller 42, in the primary transfer portion. The toner image is conveyed, borne by the belt 41, toward the secondary transfer portion formed by the belt 41 and the secondary transfer roller 45.

In the apparatus body 1A, a conveyance path 1c (first conveyance path) is formed, and extends from the feeding roller 32 toward the fixing apparatus 80 through the secondary transfer portion. In the door 20, a duplex conveyance path (second conveyance path) 20a is formed. The duplex conveyance path 20a is a path through which the sheet S that has passed through the fixing apparatus 80 passes. In a state where the door 20 is closed, the door 20 covers the conveyance path 1c. As illustrated in FIG. 2, if the door 20 is opened, at least a portion of the conveyance path 1c and at least a portion of the duplex conveyance path 20a are exposed to the outside.

In the image forming operation, in parallel with the above-described formation of a toner image, the sheet S is fed, one by one, from the sheet feeding portion 30 toward the secondary transfer portion through the conveyance path 1c. Specifically, an uppermost sheet of sheets S stacked on the stacking tray 31 is fed by the feeding roller 32 at a predetermined timing. The fed sheet S is separated from other sheets by a separation member, such as a friction roller; and the skew correction and timing adjustment are performed on the sheet S by the registration roller pair 4. After that, the sheet S is sent into the secondary transfer portion. In the secondary transfer portion, the toner image is transferred from the belt 41 to the sheet S by the secondary transfer roller 45 being applied with a voltage. The toner that has not been transferred to the sheet S is removed from the belt 41 by a cleaning blade (cleaning member) 43A disposed in the cleaning portion 43.

The sheet S to which the toner image has been transferred in the secondary transfer portion is conveyed to the fixing apparatus 80. In the fixing portion 81, the sheet S is heated and pressed, so that the toner image is fixed to the sheet S. The sheet S that has passed through the fixing portion 81 reaches the switching guide 5 that serves as a path switching portion.

The switching guide 5 can move between a sheet discharging position and a reversing position. The sheet discharging position is a position in which the switching guide 5 guides the sheet S that has passed through the fixing apparatus 80, toward a discharging path 1d. The reversing position is a position in which the switching guide 5 guides the sheet S that has passed through the fixing apparatus 80, toward a reversing path 1e. In a case where the single-side printing is performed for forming an image on one side of the sheet S, the sheet S is guided to the discharging path 1d by the switching guide 5, and is discharged to a discharging tray 1f formed in an upper portion of the apparatus body 1A.

On the other hand, in a case where the double-side printing is performed for forming images on one side and the back side of the sheet S, the sheet S is guided to the reversing path 1e by the switching guide 5. After the sheet S is guided to the reversing path 1e, the conveyance direction of the sheet S is reversed, and the sheet S is conveyed toward the secondary transfer portion through the duplex conveyance path 20a formed in the door 20. After that, a toner image is transferred to the back side of the sheet S in the secondary transfer portion. Then the sheet S passes through the fixing apparatus 80, is guided to the discharging path 1d by the switching guide 5, and is discharged to the discharging tray 1f of the apparatus body 1A.

As described above, in the closed position, the door 20 covers the opening 1A1 and at least a portion of the conveyance path 1c of the sheet S. The door 20 includes the duplex conveyance path 20a. If the sheet S is stuck (which is hereinafter referred to as jam), a user of the printer 1 can eliminate the jam by removing the sheet S from one end side (i.e., +X side) of the apparatus body 1A. Specifically, a user can remove the sheet S by accessing the interior of the apparatus body 1A, by moving the door 20 to the open position. If a portion of the sheet S that has passed through the fixing apparatus 80 is exposed to the outside of the apparatus body 1A, a user can remove the sheet S by pulling the sheet S from the outside of the apparatus body 1A, without opening the door 20.

Furthermore, a user of the printer 1 can move the transfer unit 40 and the tray unit 50 to the outside of the apparatus body 1A, from the one end side of the apparatus body 1A; and thereby can perform various types of work, such as condition check, maintenance, and replacement, on the transfer unit 40 and the cartridge P.

That is, in the printer 1, the fixing apparatus 80 is disposed on one end side of the apparatus body 1A, and the transfer unit 40 and the tray unit 50 can be moved to the outside and inside of the apparatus body 1A through the one end side of the apparatus body 1A. Thus, a user can eliminate the jam, access the fixing apparatus 80, and operate the transfer unit 40 and the tray unit 50, from one direction.

In the printer 1 of the present embodiment, the front surface is on the door 20 side (i.e., the +X side). Thus, it is only necessary to secure the space for performing various types of work, such as eliminating the jam and operating the transfer unit 40 and the tray unit 50, from the front-surface side of the printer 1. Thus, any space for performing the work from the left-surface side, the right-surface side, the back-surface side, or the top-surface side may not be secured. As a result, the printer 1 can be installed, with the space saved.

If the transfer unit 40 or the tray unit 50 is drawn from the other end side of the apparatus body 1A, a user has to access both end sides of the apparatus body 1A for eliminating the jam and drawing the transfer unit 40 or the tray unit 50. In addition, if one of the transfer unit 40 and the tray unit 50 is drawn from one end side of the apparatus body 1A and the other of the transfer unit 40 and the tray unit 50 is drawn from the other end side, a user also has to access both end sides of the apparatus body 1A. Thus, not only the space for performing work from the front-surface side of the apparatus body 1A, but also the space for performing work from the back-surface side of the apparatus body 1A becomes necessary, so that the area for installing the printer 1 increases.

In addition, in the present embodiment, the sheet S can be supplied from one end side of the apparatus body 1A. Thus, it is only necessary to secure the space for supplying the sheet S from the front-surface side. As a result, the printer 1 can be installed, with the space saved.

### Cartridge

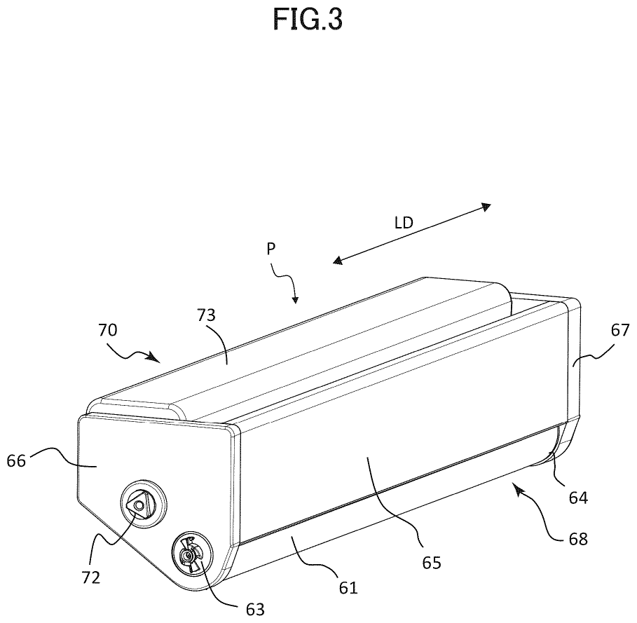

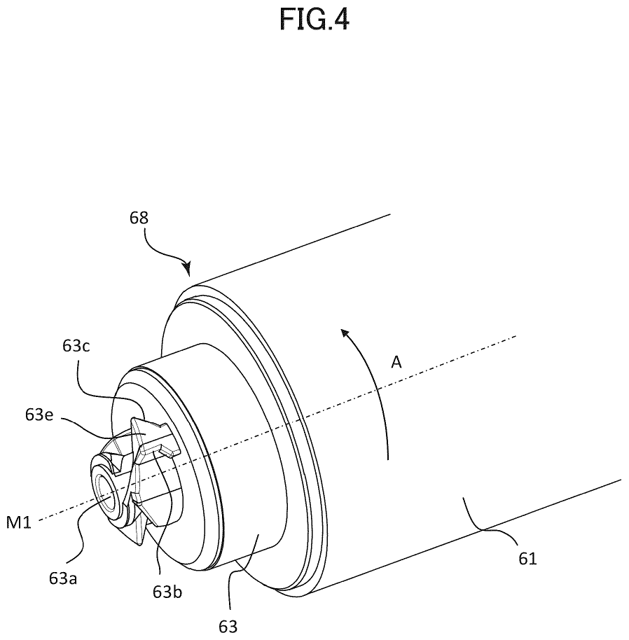

Next, a configuration of the cartridge P will be described with reference to FIGS. 3 and 4. FIG. 3 is a perspective view illustrating the cartridge P that is a process cartridge. FIG. 4 is an enlarged perspective view illustrating a drum coupling 63.

As illustrated in FIG. 3, the cartridge P includes a drum unit 68 and a developing unit 70. In addition, the cartridge P includes a first side cover 66 and a second side cover 67 that are fixed to both ends of the drum unit 68 and the developing unit 70 in a longitudinal direction LD of the cartridge P. The developing unit 70 is rotatably supported by the first side cover 66 and the second side cover 67.

The drum unit 68 is constituted by the photosensitive drum 61, the charging roller 62, a drum frame 65, and the like. In addition, the drum coupling 63 that serves as a second driven member, and a drum flange 64 are fixed to the photosensitive drum 61. The photosensitive drum 61, the drum coupling 63, and the drum flange 64 constitute a drum unit 68. The drum coupling 63 is rotatably supported by the first side cover 66, and the drum flange 64 is rotatably supported by the second side cover 67. That is, the photosensitive drum 61 is rotatably supported by the first side cover 66 and the second side cover 67, via the drum coupling 63 and the drum flange 64.

Note that in the present embodiment, a cleaning unit (e.g., a cleaning blade) for removing the remaining toner that remains on the surface of the photosensitive drum 61 is not disposed in the drum unit 68. However, the present disclosure is not limited to this. For example, the above-described cleaning unit may be disposed in the drum unit 68.

The developing unit 70 includes the developing roller 71 that bears toner, a toner conveyance roller (toner supply roller) (not illustrated), a developing blade (not illustrated), a developing coupling 72, and a developing frame 73. The developing roller 71 supplies toner stored in a toner storage chamber disposed in the developing frame 73, to the photosensitive drum 61; and thereby develops an electrostatic latent image formed on the photosensitive drum 61, into a toner image. The toner conveyance roller supplies the toner stored in the toner storage chamber, to the developing roller 71. The developing blade regulates the layer thickness of toner borne by the developing roller 71. The developing roller 71 and the toner conveyance roller are driven by the rotational drive (driving force) applied from the apparatus body 1A to the developing coupling 72 that serves as a first driven member. The developing coupling 72 is a member different from the drum coupling 63.

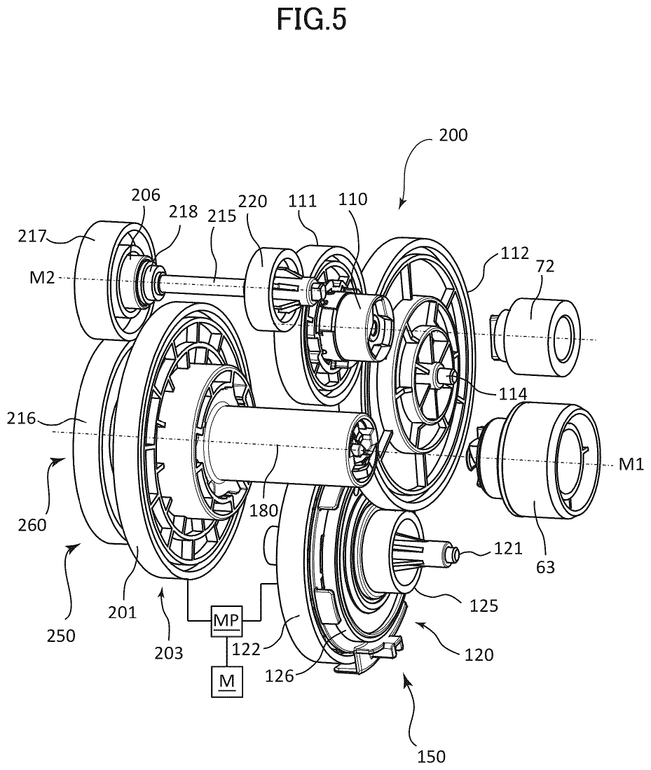

As illustrated in FIG. 4, the drum coupling 63 includes a circular hole portion 63a and projection portions 63e, which will be described in detail below. Specifically, two projection portions 63e are disposed at positions separated from each other by 180 degrees in a circumferential direction around a rotation axis M1. In each projection portion 63c, a driving-force receiving portion 63b and a brake-force receiving portion 63c are formed. The circular hole portion 63a can engage with a positioning boss 180i formed in a drum driving coupling 180 of a below-described drum-driving-force transmission unit 203. The circular hole portion 63a and the positioning boss 180i engage with each other, so that the axis of the drum-driving-force transmission unit 203 and the axis of the drum coupling 63 are aligned with each other. The driving-force receiving portion 63b receives rotational drive from the drum-driving-force transmission unit 203, and the brake-force receiving portion 63c receives brake force from a below-described brake-force applying unit 260 (see FIG. 5A). The driving-force receiving portion 63b is positioned upstream of the brake-force receiving portion 63c in a direction indicated by an arrow A, which is a rotational direction of the drum unit 68. In the present embodiment, two driving-force receiving portions 63b and two brake-force receiving portions 63c are formed.

Next, with reference to FIG. 5, a configuration of a driving-force transmission mechanism 200 disposed in the apparatus body 1A will be described. FIG. 5 is a perspective view illustrating the driving-force transmission mechanism 200. As illustrated in FIG. 5, the driving-force transmission mechanism 200 includes a motor M that serves as a driving source, an output portion MP that outputs the rotational drive of the motor M, a first driving-force transmission unit 150 that serves as a first driving-force transmission portion, and a second driving-force transmission unit 250 that serves as a second driving-force transmission portion. The output portion MP may be a gear formed on or attached to the shaft of the motor M, or may be another gear that meshes with the gear. The first driving-force transmission unit 150 and the second driving-force transmission unit 250 are connected to the output portion MP. In other words, the transmission path of the rotational drive of the motor M branches from the output portion MP into the first driving-force transmission unit 150 and the second driving-force transmission unit 250. Note that another driving-force transmission member, such as a gear, may be disposed in the driving-force transmission path between the output portion MP and the first driving-force transmission unit 150, or in the driving-force transmission path between the output portion MP and the second driving-force transmission unit 250.

The first driving-force transmission unit 150 includes a clutch unit 120 that serves as a clutch mechanism, a gear 112, a development driving gear 111 that serves as a rotating body, and a development driving coupling 110; and transmits the rotational drive output from the motor M, to the developing coupling 72. The development driving gear 111 and the development driving coupling 110 are positioned between the clutch unit 120 and the developing coupling 72. In addition, the development driving gear 111 is positioned between the development driving coupling 110 and the clutch unit 120.

The second driving-force transmission unit 250 includes the drum-driving-force transmission unit 203, the brake-force applying unit 260, a brake portion 206, a rotary shaft 215, and a gear 220; and transmits the rotational drive output from the motor M, to the drum coupling 63. The second driving-force transmission unit 250 is connected to the first driving-force transmission unit 150 at a position between the developing coupling 72 and the clutch unit 120. More specifically, the second driving-force transmission unit 250 is connected to the first driving-force transmission unit 150 at a position between the development driving coupling 110 and the clutch unit 120. In the present embodiment, the gear 220 of the second driving-force transmission unit 250 meshes with the development driving gear 111, so that the second driving-force transmission unit 250 is connected to the first driving-force transmission unit 150. The brake portion 206 is positioned between the output portion MP and the gear 220. The gear 220 may be referred to as a connection portion connected to the first driving-force transmission unit 150.

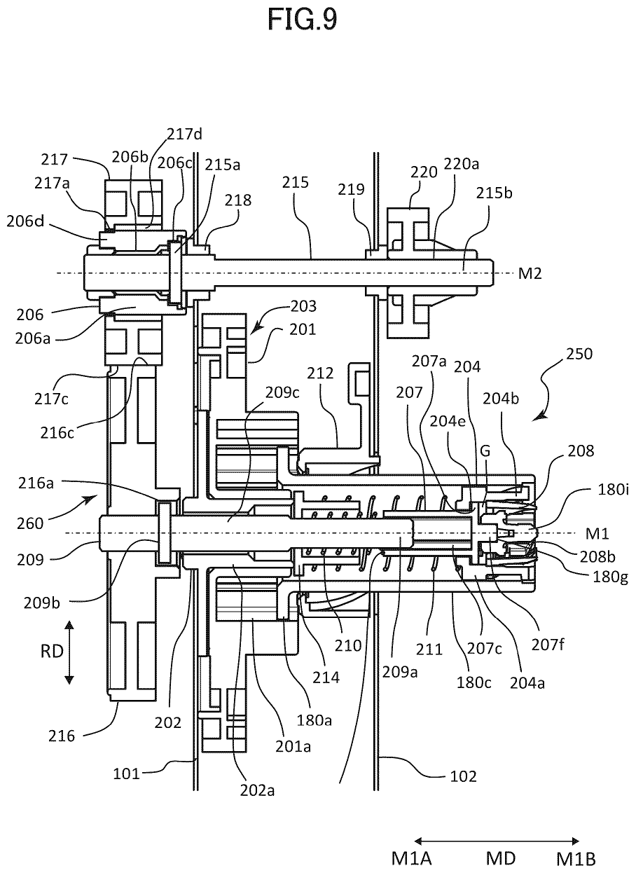

The development driving gear 111 of the first driving-force transmission unit 150 is rotatably supported by a shaft (not illustrated) fixed to a driving frame 102 (see FIG. 9), and is drivingly connected to the developing coupling 72. The rotational drive (driving force) output from the motor M is transmitted to the development driving gear 111 via the output portion MP, the clutch unit 120, and the gear 112. The development driving coupling 110 is supported so as to be able to move in a thrust direction, with respect to the development driving gear 111; and is urged toward the developing coupling 72 by an urging member (not illustrated).

In addition, the rotational drive (driving force) output from the motor M is transmitted to the drum coupling 63 via the below-described drum-driving-force transmission unit 203. The drum coupling 63, the drum-driving-force transmission unit 203, and a gear 216 rotate around a rotation axis M1. Note that in FIG. 5, the developing coupling 72 and the development driving coupling 110 are illustrated, separated from each other, and the drum coupling 63 and a drum driving coupling 180 are illustrated, separated from each other for convenience of description. In the practical use, however, the developing coupling 72 and the development driving coupling 110 are engaged with each other, and the drum coupling 63 and the drum driving coupling 180 are engaged with each other for transmitting the driving force.

In addition, the rotational drive (driving force) output from the motor M is transmitted to the development driving gear 111 via the output portion MP, the drum-driving-force transmission unit 203, the drum coupling 63, the brake-force applying unit 260, the brake portion 206, the rotary shaft 215, and the gear 220. That is, the rotational drive of the motor M is transmitted to the development driving gear 111 via two paths: a first driving-force transmission path that passes through the first driving-force transmission unit 150, and a second driving-force transmission path that passes through the second driving-force transmission unit 250.

### Clutch Unit

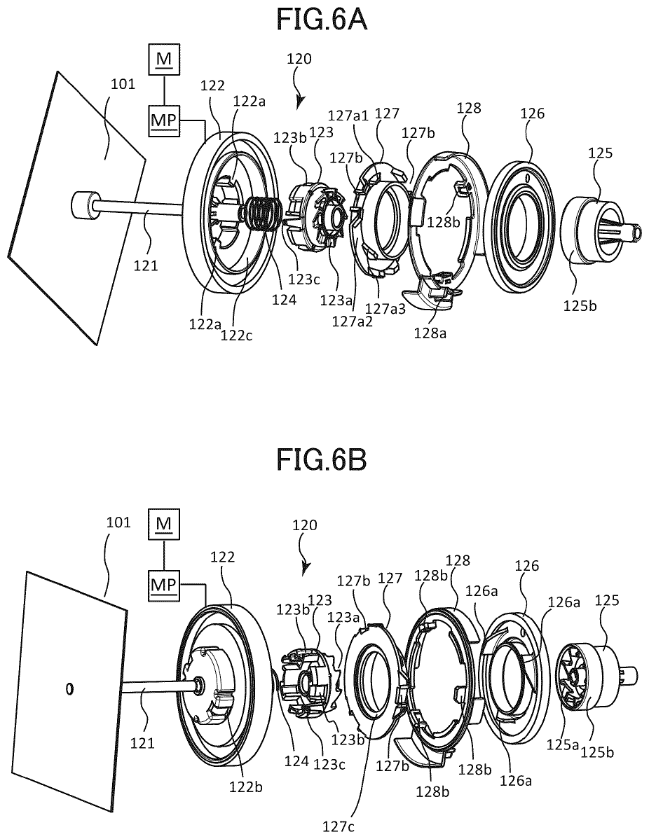

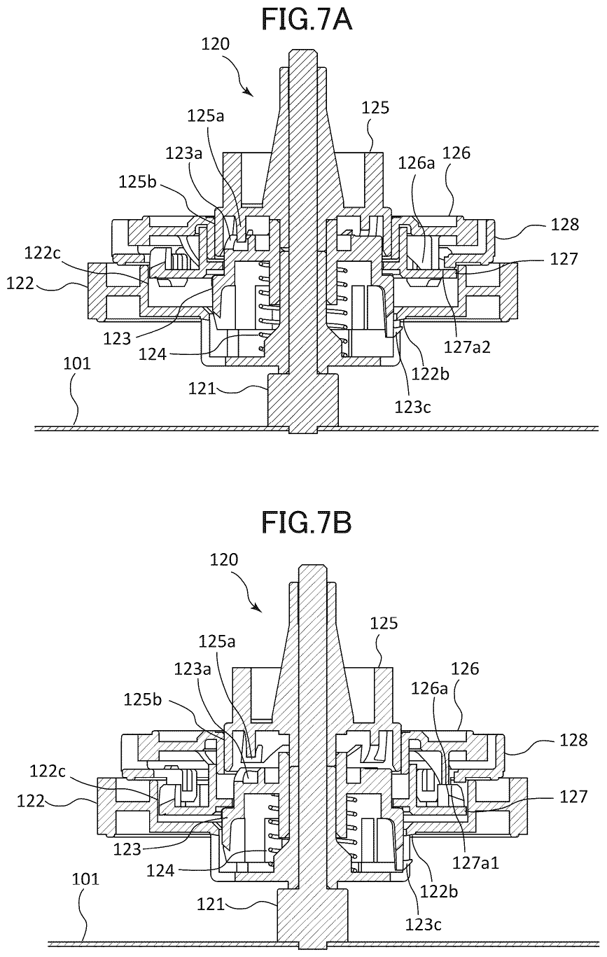

Next, the clutch unit 120 of the first driving-force transmission unit 150 will be described with reference to FIGS. 6A to 7B. FIG. 6A is an exploded perspective view illustrating the clutch unit 120. FIG. 6B is another exploded perspective view illustrating the clutch unit 120. FIG. 7A is a cross-sectional view illustrating the clutch unit 120 that is in a transmission state. FIG. 7B is a cross-sectional view illustrating the clutch unit 120 that is in a non-transmission state.

As illustrated in FIGS. 6A and 6B, the clutch unit 120 includes a clutch driving gear 122, an urging member 124, a driving-side engagement member 123, a releasing member 127, a cam holding member 128, a cam gear member 126, and a clutch driven gear 125. In addition, a driving frame 101 is disposed in the apparatus body 1A, and a shaft 121 is fixed to the driving frame 101.

The rotational drive output from the motor M is transmitted to the clutch driving gear 122. The clutch driving gear 122 is rotatably supported by the shaft 121. In addition, the driving-side engagement member 123 and the clutch driven gear 125 are also supported rotatably by the shaft 121. In the clutch driving gear 122, an inner side of a gear portion formed on an outer circumferential surface is recessed. An inner circumferential surface of the clutch driving gear 122 serves as a positioning surface that positions the driving-side engagement member 123, and as a sliding surface.

The driving-side engagement member 123 includes a ratchet portion 123a, a groove portion 123b, and a claw portion 123c. The groove portion 123b is engaged with a rotation prevention portion 122a of the clutch driving gear 122. Thus, the driving-side engagement member 123 rotates around the shaft 121, together with the clutch driving gear 122. In addition, the driving-side engagement member 123 can move with respect to the clutch driving gear 122, in an axis direction of the shaft 121.

The urging member 124 is disposed between the clutch driving gear 122 and the driving-side engagement member 123. The urging member 124 urges the driving-side engagement member 123 in a direction in which the driving-side engagement member 123 is separated from the clutch driving gear 122, and in which the driving-side engagement member 123 engages with the clutch driven gear 125. In the present embodiment, the urging member 124 is constituted by a compression spring. Since the driving-side engagement member 123 is urged by the urging member 124, the driving-side engagement member 123 is held in a state where the driving-side engagement member 123 is abutted against an abutment surface 127c of the releasing member 127. The driving-side engagement member 123 moves together with the releasing member 127, in the axis direction of the shaft 121 (which is equal to a below-described axis direction MD).

The claw portion 123c formed in an outer circumferential surface of the driving-side engagement member 123 is locked to a separation prevention portion 122b formed in the clutch driving gear 122. Thus, the driving-side engagement member 123 is prevented from falling off from the clutch driving gear 122 that is caused by the urging force of the urging member 124. That is, the driving-side engagement member 123 is prevented from being disconnected from the clutch driving gear 122, by the claw portion 123c engaging with the separation prevention portion 122b.

The clutch driven gear 125 includes a ratchet portion 125a and a cylindrical portion 125b. The ratchet portion 125a faces the ratchet portion 123a of the driving-side engagement member 123. In addition, the clutch driven gear 125 is abutted against the driving frame 102 (see FIG. 9), so that the clutch driven gear 125 is prevented from moving in a second direction MIB.

As illustrated in FIG. 7A, if the ratchet portion 123a of the driving-side engagement member 123 engages with the ratchet portion 125a of the clutch driven gear 125, the state of the clutch unit 120 becomes a transmission state. In addition, as illustrated in FIG. 7B, if the ratchet portion 123a of the driving-side engagement member 123 separates from the ratchet portion 125a of the clutch driven gear 125, the state of the clutch unit 120 becomes a non-transmission state. In a case where the clutch unit 120 is in the transmission state, the rotational drive output from the motor M is transmitted to the development driving gear 111. On the other hand, in a case where the clutch unit 120 is in the non-transmission state, the rotational drive output from the motor M is not transmitted to the development driving gear 111. That is, the state of the clutch unit 120 can be switched between the transmission state where the rotational drive output from the motor M is transmitted to the developing coupling 72, and the non-transmission state where the rotational drive output from the motor M is not transmitted to the developing coupling 72.

The cam holding member 128 includes a rotation prevention portion 128a and a projection portion 128b, and is supported by an inner circumference portion 122c of the clutch driving gear 122 that serves as a shaft. In addition, the rotation prevention portion 128a is engaged with a rotation prevention hole (not illustrated) of the driving frame 102 (see FIG. 9), so that the cam holding member 128 is prevented from rotating around the shaft 121. The cam gear member 126 includes a plurality of (three in the present embodiment) cam portions 126a that projects toward the releasing member 127, and is rotatably supported by the cylindrical portion 125b of the clutch driven gear 125.

The releasing member 127 includes a recess portion 127b, a top surface portion 127al that can engage with the cam portion 126a, a bottom surface portion 127a2, and a slope surface portion 127a3. Since the recess portion 127b engages with the projection portion 128b of the cam holding member 128, the releasing member 127 rotates around the shaft 121, together with the cam holding member 128. Note that the releasing member 127 can move relative to the cam holding member 128 in the axis direction of the shaft 121.

The cam gear member 126 is driven and controlled by the rotational drive from the motor M being applied and not applied to the cam gear member 126 by a solenoid and a gear train (not illustrated). Note that in the present embodiment, the cam gear member 126 is controlled such that the cam gear member 126 turns one third, or 120 degrees, when the solenoid operates one time. In another case, another actuator may be used instead of the solenoid.

If the cam gear member 126 rotates, and the cam portion 126a of the cam gear member 126 and the top surface portion 127al of the releasing member 127 are in phase with each other, the top surface portion 127al of the releasing member 127 is pushed by the cam portion 126a toward the left direction in FIGS. 6A and 6B. With this operation, the releasing member 127 and the driving-side engagement member 123 are moved in a direction in which the releasing member 127 and the driving-side engagement member 123 are separated from the clutch driven gear 125, so that the ratchet portion 123a of the driving-side engagement member 123 and the ratchet portion 125a of the clutch driven gear 125 are separated from each other. As a result, the state of the clutch unit 120 becomes a non-transmission state illustrated in FIG. 7B.

In contrast, if the cam gear member 126 rotates, and the cam portion 126a of the cam gear member 126 and the top surface portion 127al of the releasing member 127 are out of phase from each other, the driving-side engagement member 123 is moved by the urging force of the urging member 124, toward a direction in which the driving-side engagement member 123 moves closer to the clutch driven gear 125. In this case, the cam portion 126a of the cam gear member 126 contacts the bottom surface portion 127a2 of the releasing member 127. As a result, the ratchet portion 123a of the driving-side engagement member 123 and the ratchet portion 125a of the clutch driven gear 125 engage with each other, so that the state of the clutch unit 120 becomes a transmission state illustrated in FIG. 7A.

### Second Driving-Force Transmission Unit

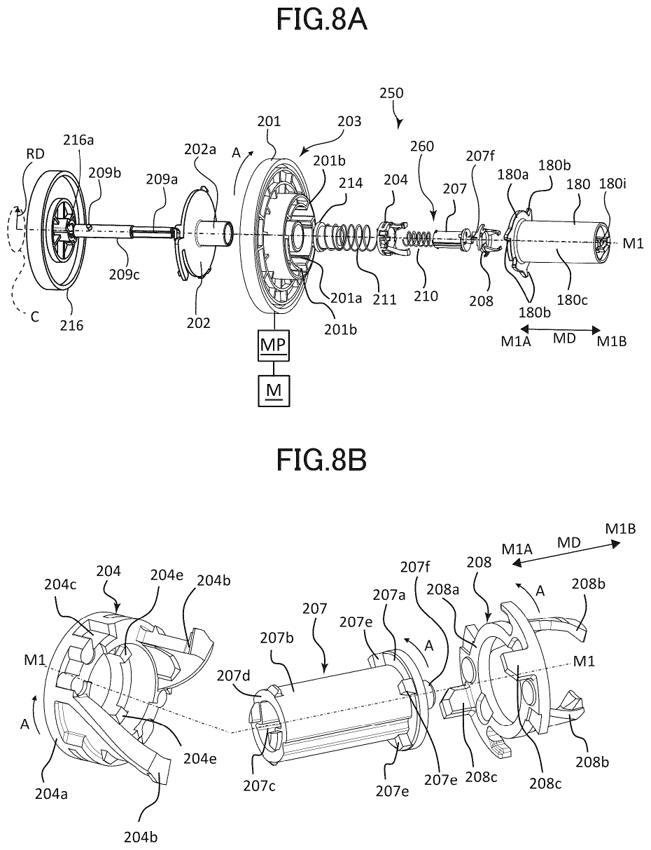

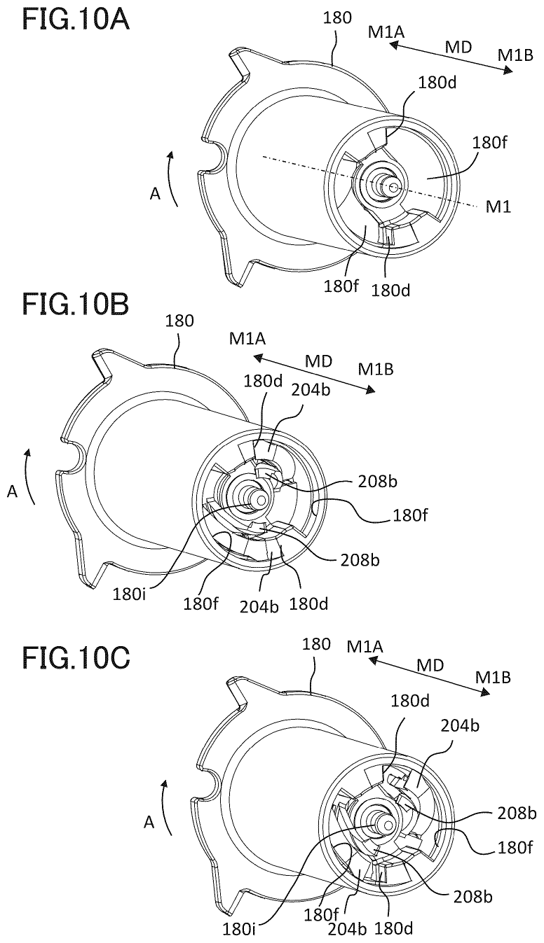

Next, with reference to FIGS. 8A to 10C, a configuration of the second driving-force transmission unit 250 disposed in the apparatus body 1A will be described. FIG. 8A is an exploded perspective view illustrating the second driving-force transmission unit 250. FIG. 8B is an exploded perspective view illustrating a first brake-engagement member 204, a second brake-engagement member 208, and a brake transmission member 207. FIG. 9 is a cross-sectional view illustrating the second driving-force transmission unit 250. FIG. 10A is a perspective view illustrating the drum driving coupling 180. FIG. 10B is a perspective view illustrating the drum driving coupling 180, and coupling engagement portions 204b and 208b. FIG. 10C is a perspective view illustrating a state where the coupling engagement portions 204b and 208b rotate in a through-hole 180f.

As illustrated in FIGS. 8A and 9, the second driving-force transmission unit 250 includes the drum-driving-force transmission unit 203 that serves as a driving-force transmission portion, the brake-force applying unit 260 that serves as a brake-force applying portion, the brake portion 206, the rotary shaft 215, and the gear 220. As illustrated in FIG. 9, the apparatus body 1A includes the driving frames 101 and 102 that are fixing members, and a shaft receiving member 202 fixed to the driving frame 101.

Each of the driving frames 101 and 102 is constituted by a metal plate, and extends in a radial direction RD that serves as an intersecting direction that intersects (at right angles) the axis direction MD. In addition, the driving frames 101 and 102 are disposed, spaced from each other in the axis direction MD. Note that the radial direction RD is a radial direction of an imaginary circle C around the rotation axis M1. In the present embodiment, the radial direction RD is a direction orthogonal to the axis direction MD. The shaft receiving member 202 is fixed to the driving frame 101 such that the shaft receiving member 202 cannot rotate with respect to the driving frame 101, around the rotation axis M1.

The rotation axis M1 of the drum-driving-force transmission unit 203 extends in the axis direction MD, and is equal to the rotation axis of the drum coupling 63. In addition, the axis direction MD is a direction parallel to the longitudinal direction LD of the cartridge P illustrated in FIG. 3. In the following description, a direction of the axis direction MD that extends from the driving frame 101 toward a driving gear 201 of the drum-driving-force transmission unit 203 is referred to as a second direction MIB, and a direction of the axis direction MD that extends from the driving frame 101 toward the gear 216 is referred to as a first direction M1A. The first direction M1A and the second direction MIB are directions opposite to each other.

The shaft receiving member 202 includes a cylindrical portion 202a formed cylindrically and extending in the second direction MIB. The drum-driving-force transmission unit 203 includes the driving gear 201 and the drum driving coupling 180. The driving gear 201 includes a fitting portion 201a and a plurality of (three in the present embodiment) recess portions 201b. The fitting portion 201a is recessed in the first direction M1A. The recess portions 201b are formed in the fitting portion 201a, and recessed in the radial direction RD. The three recess portions 201b are formed at regular intervals in a circumferential direction around the rotation axis M1. The driving gear 201 is rotatably supported by the cylindrical portion 202a of the shaft receiving member 202, and is rotated by the rotational drive transmitted from the motor M.

The drum driving coupling 180 includes a cylindrical portion 180c, a flange portion 180a, and the positioning boss 180i. The cylindrical portion 180c is formed cylindrically, and extends in the axis direction MD. The flange portion 180a is formed at an end portion of the cylindrical portion 180c in the first direction M1A, and the positioning boss 180i is formed at an end portion of the cylindrical portion 180c in the second direction MIB. In the flange portion 180a, a plurality of (three in the present embodiment) projection portions 180b are formed so as to project in the radial direction RD. The flange portion 180a fits in the fitting portion 201a of the driving gear 201 in the first direction M1A, and each projection portion 180b engages with a corresponding one of the recess portions 201b of the above-described driving gear 202. Thus, the drum driving coupling 180 rotates around the rotation axis M1, together with the driving gear 201. The positioning boss 180i engages with the circular hole portion 63a (see FIG. 4) of the drum coupling 63 in a state where the cartridge P is attached to the apparatus body 1A.

As illustrated in FIG. 10A, driving-force transmission surfaces 180d and 180d, and through-holes 180f and 180f are formed around the positioning boss 180i of the drum driving coupling 180. The through-holes 180f and 180f pass through the drum driving coupling 180 in the axis direction MD. The driving-force transmission surfaces 180d and 180d are separated from each other by 180 degrees in a circumferential direction around the rotation axis M1. The through-holes 180f and 180f are also separated from each other by 180 degrees in a circumferential direction around the rotation axis M1. The driving-force transmission surfaces 180d and 180d can engage with the driving-force receiving portions 63b of the drum coupling 63.

As illustrated in FIG. 8A, the brake-force applying unit 260 that serves as a brake-force applying portion includes gears 216 and 217, a brake transmission shaft 209, a spring holding member 214, the first brake-engagement member 204, and the second brake-engagement member 208. In addition, the brake-force applying unit 260 also includes a brake transmission member 207, a brake engagement spring 211, and a drum-driving coupling spring 210. The spring holding member 214, the first brake-engagement member 204, the second brake-engagement member 208, the brake transmission member 207, the brake engagement spring 211, and the drum-driving coupling spring 210 are disposed in the internal space of the cylindrical portion 180c of the drum driving coupling 180.

As illustrated in FIGS. 8A and 9, the brake transmission shaft 209 includes a shaft portion 209c extending in the axis direction MD, an engagement pin 209b fixed to the shaft portion 209c and extending in the radial direction RD, and a groove portion 209a formed in the shaft portion 209c and extending in the axis direction MD. The shaft portion 209c passes through the cylindrical portion 202a of the shaft receiving member 202, and rotatably supports the below-described spring holding member 214. The engagement pin 209b is disposed in a downstream end portion of the brake transmission shaft 209 in the first direction M1A. The groove portion 209a is formed in an upstream end portion of the brake transmission shaft 209 in the first direction M1A. Thus, the engagement pin 209b and the groove portion 209a are disposed opposite to each other with respect to the driving frame 101 in the axis direction MD.

The engagement pin 209b is engaged with an engaging portion 216a of the gear 216 supported by the brake transmission shaft 209 that serves as a shaft. Thus, the gear 216 and the brake transmission shaft 209 rotate together with each other. In addition, the rotary shaft 215 is fixed to the driving frames 101 and 102. The rotary shaft 215 extends along a rotation axis M2 that extends in parallel with the rotation axis M1, and that is positioned at a position different from the position of the rotation axis M1 in the radial direction RD. In addition, an inner ring 206b of the brake portion 206 is fixed to the rotary shaft 215.

The brake portion 206 includes an outer ring 206a that serves as a first rotary member, and the inner ring 206b accommodated in the outer ring 206a and serving as a second rotary member. That is, the brake portion 206 is disposed at a position shifted from the rotation axis M1 in the radial direction RD. The inner ring 206b includes an engagement hole 206c that engages with an engagement pin 215a fixed to the rotary shaft 215. Since the engagement pin 215a engages with the engagement hole 206c, the inner ring 206b is attached to the rotary shaft 215 so as not to rotate relative to the rotary shaft 215. That is, the inner ring 206b and the rotary shaft 215 rotate together around the rotation axis M2. In addition, the inner ring 206b is drivingly connected to the development driving gear 111 (see FIG. 5) via the rotary shaft 215 and the gear 220. The outer ring 206a rotates relative to the inner ring 206b if the outer ring 206a is applied with a torque whose value is equal to or higher than a predetermined value.

When the outer ring 206a rotates relative to the inner ring 206b, the outer ring 206a rotates while receiving brake force (load) from the inner ring 206b in the rotational direction. The method of generating the brake force may be appropriately selected from a method that uses friction, a method that uses viscosity, and the like. In the present embodiment, a torque limiter is used in the brake portion 206. For example, the torque limiter uses the frictional force between a built-in spring and an inner ring, and thereby limits the torque transmitted from the input side to the output side, to a predetermined limit value. If the torque applied to the outer ring 206a has a value equal to or lower than a predetermined limit value, the outer ring 206a rotates together with the inner ring 206b. In another case, a rotary damper may be used in the brake portion 206. The rotary damper uses brake force produced by the viscosity resistance of oil.

The outer ring 206a includes a projection portion 206d. The projection portion 206d engages with an engaging portion 217a formed in the gear 217, so that the outer ring 206a rotates together with the gear 217. That is, the outer ring 206a and the gear 217 rotate together around the rotation axis M2. For example, the projection portion 206d and the engaging portion 217a are spline-engaged with each other.

The gear 217 includes a gear portion 217c, and an accommodating portion 217d that accommodates the brake portion 206. The gear portion 217c meshes with a gear portion 216c of the gear 216. The accommodating portion 217d is disposed inside the gear portion 217c in the radial direction RD. That is, the accommodating portion 217d is disposed closer to the rotation axis M2 than the gear portion 217c is.

The groove portion 209a formed in the brake transmission shaft 209 is formed by performing the spline processing on the shaft portion 209c. The groove portion 209a may be a plurality of groove portions formed in a circumferential direction around the rotation axis M1. However, the groove portion 209a may be a single groove portion. In addition, the groove portion 209a and a projection portion 207c of the brake transmission member 207 are spline-engaged with each other. The projection portion 207c projects inward from the inner circumferential surface of the brake transmission member 207 in the radial direction RD. The projection portion 207c may be a plurality of projection portions whose number is the same as the number of the groove portions 209a. Since the groove portion 209a and the projection portion 207c are spline-engaged with each other, the brake transmission member 207 rotates together with the brake transmission shaft 209, around the rotation axis M1. In addition, the brake transmission member 207 can move with respect to the brake transmission shaft 209 in the axis direction MD.

As illustrated in FIG. 8B, the brake transmission member 207 includes a shaft portion 207b and a flange portion 207a. The shaft portion 207b extends in the axis direction MD. The flange portion 207a extends in the radial direction RD, from a downstream end of the shaft portion 207b in the second direction MIB. The flange portion 207a includes a plurality of (four in the present embodiment) projections 207e that project in the first direction M1A. The plurality of projections 207e is formed at regular intervals in a circumferential direction around the rotation axis M1.

As illustrated in FIGS. 8A, 8B, and 9, the drum-driving coupling spring 210 that is a compression spring is disposed, contracted, between an end surface 207d of the brake transmission member 207 in the first direction M1A, and the spring holding member 214. The drum-driving coupling spring 210 applies repulsive force (urging force, elastic force) to the spring holding member 214 and the brake transmission member 207, in a direction in which the spring holding member 214 and the brake transmission member 207 are separated from each other.

As illustrated in FIG. 8B, the first brake-engagement member 204 includes a flange portion 204a and coupling engagement portions 204b. The coupling engagement portions 204b project, like claws, from the flange portion 204a in the second direction MIB.

The flange portion 204a includes projection portions 204e that engage with the projections 207e of the brake transmission member 207, and recess portions 204c. In the present embodiment, four projection portions 204e and two recess portions 204c are formed. However, the number of projection portions 204e and the number of the recess portions 204c are not limited to particular numbers. Since the projection portions 204e of the first brake-engagement member 204 are engaged with the projections 207e of the brake transmission member 207, the first brake-engagement member 204 rotates together with the brake transmission member 207, around the rotation axis M1.

The second brake-engagement member 208 includes a flange portion 208a and coupling engagement portions 208b. The coupling engagement portions 208b project, like claws, from the flange portion 208a in the second direction MIB. The coupling engagement portions 208b are disposed inside the coupling engagement portions 204b of the first brake-engagement member 204 in the radial direction RD. In the present embodiment, the second brake-engagement member 208 includes two coupling engagement portions 208b. However, the number of the coupling engagement portions 208b is not limited to a particular number. In the flange portion 208a, projection portions 208c are formed so as to project in the first direction M1A. Since the projection portions 208c of the second brake-engagement member 208 are engaged with the recess portions 204c of the first brake-engagement member 204, the second brake-engagement member 208 rotates together with the first brake-engagement member 204, around the rotation axis M1. In addition, the first brake-engagement member 204 and the second brake-engagement member 208 are coupled to each other such that the first brake-engagement member 204 and the second brake-engagement member 208 move together also in the axis direction MD. Thus, the first brake-engagement member 204 and the second brake-engagement member 208 may be collectively and simply referred to as brake engagement members (204, 208).

As illustrated in FIG. 9, the flange portion 207a of the brake transmission member 207 is disposed between the flange portion 204a of the first brake-engagement member 204 and the flange portion 208a of the second brake-engagement member 208 in the axis direction MD. In addition, the flange portion 207a is interposed between the flange portion 204a and the flange portion 208a in the axis direction MD, with a clearance G being formed between the flange portion 204a and the flange portion 208a.

As illustrated in FIGS. 8A and 9, a brake engagement spring 211 that is a compression spring is disposed, contracted, between the spring holding member 214 and the flange portion 204a of the first brake-engagement member 204. The brake engagement spring 211 applies repulsive force (urging force, elastic force) to the spring holding member 214 and the first brake-engagement member 204 in a direction in which the spring holding member 214 and the first brake-engagement member 204 are separated from each other. Since the spring holding member 214 is urged by the brake engagement spring 211 and the drum-driving coupling spring 210 in the first direction M1A, the spring holding member 214 is abutted against an end surface of the cylindrical portion 202a of the shaft receiving member 202.

In addition, as illustrated in FIGS. 8B and 9, the brake transmission member 207 includes a boss portion 207f that projects in the second direction MIB. The brake transmission member 207 receives the urging force of the brake engagement spring 211 via the flange portion 204a of the first brake-engagement member 204, and receives the urging force of the drum-driving coupling spring 210 directly. Thus, the boss portion 207f of the brake transmission member 207 is abutted against an abutment surface 180g of the drum driving coupling 180.

The drum driving coupling 180 also receives the urging force of the brake engagement spring 211 and the drum-driving coupling spring 210 via the brake transmission member 207, and is urged in the second direction MIB. As illustrated in FIG. 9, the flange portion 180a of the drum driving coupling 180 is abutted against a regulation portion 212 fixed to the driving frame 102, so that the drum driving coupling 180 is prevented from moving in the second direction MIB. Thus, the drum driving coupling 180 does not fall off from the driving gear 201. In addition, if the drum driving coupling 180 receives force from the outside in the first direction M1A, the drum driving coupling 180 moves against the urging force of the brake engagement spring 211 and the drum-driving coupling spring 210 in the first direction M1A, in the range of the above-described clearance G.

As illustrated in FIG. 10B, the coupling engagement portions 204b of the first brake-engagement member 204 and the coupling engagement portions 208b of the second brake-engagement member 208 are exposed from the through-holes 180f of the drum driving coupling 180. In a state where the cartridge P is attached to the apparatus body 1A, the coupling engagement portions 204b and 208b face the drum coupling 63 via the through-holes 180f.

The through-hole 180f is formed wider than the width of each of the coupling engagement portions 204b and 208b in a circumferential direction around the rotation axis M1. Thus, as illustrated in FIG. 10C, the coupling engagement portions 204b and 208b can rotate with respect to the drum driving coupling 180, in the range of the through-hole 180f.

### Coupling Between Drum Driving Coupling and Drum Coupling

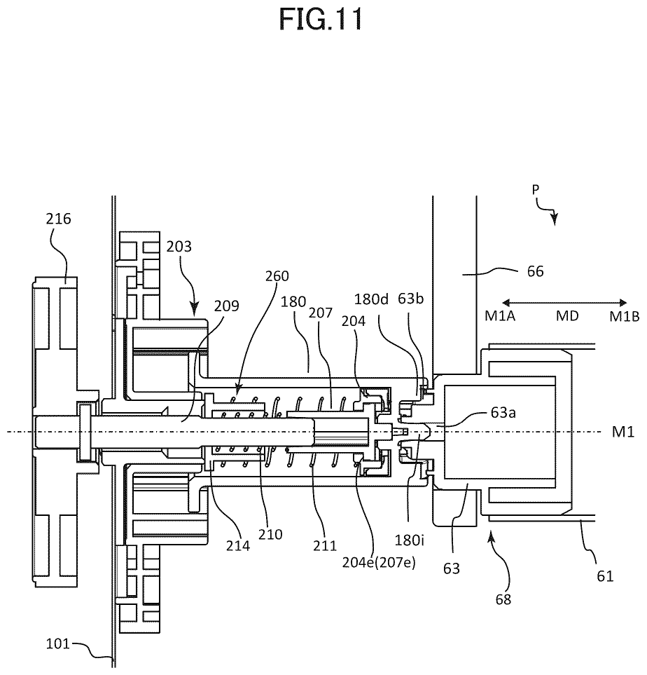

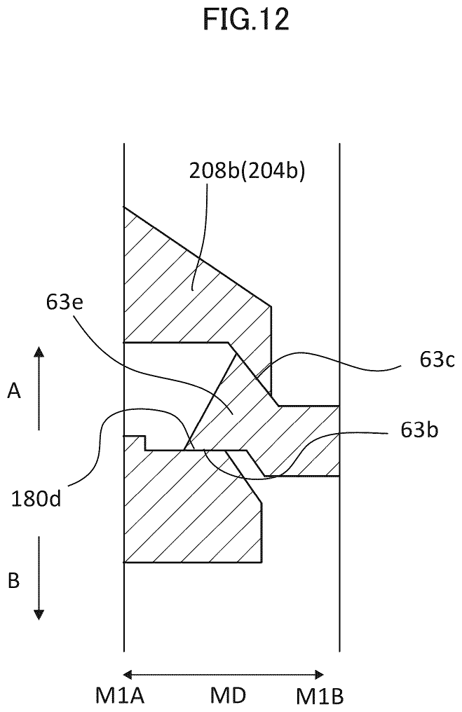

Next, the coupling between the drum driving coupling 180 and the drum coupling 63 will be described. FIG. 11 is a cross-sectional view illustrating a state where the drum driving coupling 180 and the drum coupling 63 are engaged with each other. FIG. 12 is an enlarged cross-sectional view illustrating a vicinity of the projection portion 63e of the drum coupling 63.

As illustrated in FIG. 11, if the cartridge P is attached to the apparatus body 1A, the positioning boss 180i of the drum driving coupling 180 and the circular hole portion 63a of the drum coupling 63 are engaged with each other. In this state, the drum driving coupling 180 receives force from the drum coupling 63 in the first direction M1A. Thus, the drum driving coupling 180 moves in the first direction M1A, against the urging force of the brake engagement spring 211 and the drum-driving coupling spring 210. Since the boss portion 207f of the brake transmission member 207 is abutted against the abutment surface 180g of the drum driving coupling 180, the brake transmission member 207 moves together with the drum driving coupling 180 in the first direction M1A.

Since the brake transmission member 207 moves in a direction in which the above-described clearance G (see FIG. 9) decreases, the projections 207e of the brake transmission member 207 engage with the projection portions 204e of the first brake-engagement member 204, as illustrated in FIG. 11. As a result, the brake transmission member 207, the first brake-engagement member 204, the second brake-engagement member 208, and the brake transmission shaft 209, which constitute the brake-force applying unit 260, rotate together with each other around the rotation axis M1. In addition, the inner ring 206b of the brake portion 206 rotates together with the brake transmission shaft 209.

If the driving gear 201 is driven by the motor M in a direction indicated by the arrow A in FIG. 8 (a), the drum driving coupling 180 that fits in the driving gear 201 also rotates in the direction indicated by the arrow A. Thus, as illustrated in FIG. 12, a driving-force transmission surface 180d of the drum driving coupling 180 engages with the driving-force receiving portion 63b in the direction indicated by the arrow A, and pushes the driving-force receiving portion 63b in the direction indicated by the arrow A. That is, the drum driving coupling 180 is an example of an engagement member that can engage with the driving-force receiving portion 63b of the drum unit 68. The driving-force receiving portion 63b is applied with the rotational drive (rotational force) in the direction indicated by the arrow A, so that the drum unit 68, which includes the photosensitive drum 61 and the drum coupling 63, rotates in the direction indicated by the arrow A, as illustrated in FIG. 4. The direction indicated by the arrow A serves as a first rotational direction.

On the other hand, since the photosensitive drum 61 and the drum coupling 63 rotate in the direction indicated by the arrow A, the brake-force receiving portion 63c of the drum coupling 63 engages with the coupling engagement portions 204b and 208b. In other words, the first brake-engagement member 204 and the second brake-engagement member 208 engage with the brake-force receiving portion 63c of the drum unit 68 in a direction indicated by an arrow B that is opposite to the direction indicated by the arrow A. The direction indicated by the arrow B serves as a second rotational direction. That is, the first brake-engagement member 204 and the second brake-engagement member 208 are an example of a brake engagement member that engages with the drum unit 68. The rotational drive from the motor M is transmitted from the drum driving coupling 180 to the drum coupling 63, and from the drum coupling 63 to the brake engagement members (204, 208). As described above, the first brake-engagement member 204, the second brake-engagement member 208, the brake transmission member 207, the brake transmission shaft 209, and the inner ring 206b of the brake portion 206 are drivingly connected with each other so as to rotate in a rotational direction. In addition, while rotating around the rotation axis M2 with respect to the outer ring 206a, the inner ring 206b produces brake force for applying load to the rotation of the photosensitive drum 61. The brake force is applied to the brake-force receiving portion 63c via the brake-force applying unit 260, which includes the first brake-engagement member 204 and the second brake-engagement member 208.

Thus, the drum coupling 63 is rotated in the direction indicated by the arrow A, by the rotational drive received from the drum driving coupling 180, while receiving appropriate load (brake force) from the first brake-engagement member 204 and the second brake-engagement member 208. That is, the torque necessary for rotating the drum coupling 63 increases due to the load (brake force) produced by the brake portion 206. As a result, the torque necessary for the drum driving coupling 180 to rotate the drum unit 68 is made not too low but appropriate, so that the rotation of the drum unit 68 becomes stable. That is, the unstable rotation of the drum unit 68, such as the abrupt fast rotation of the drum unit 68 due to the change in the rotational drive received from the drum driving coupling 180, can be prevented.

### Transmission of Driving Force to Developing Coupling

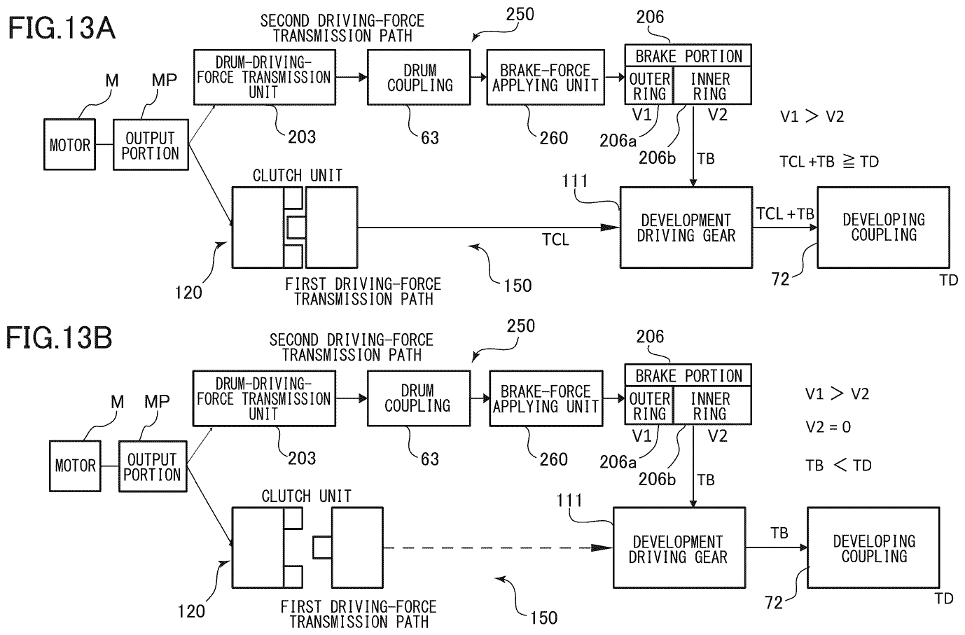

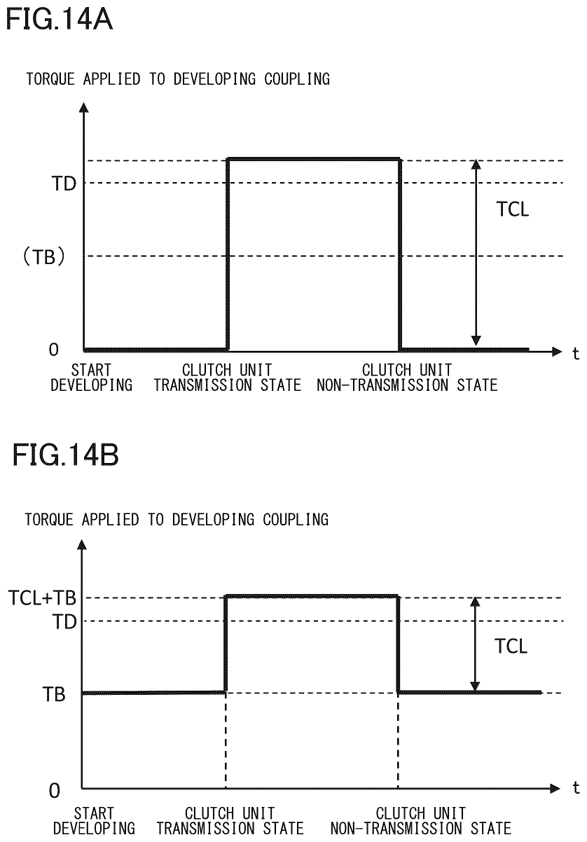

Next, the transmission of the driving force from the motor M to the developing coupling 72 will be described with reference to FIGS. 13A to 14B. FIG. 13A is a schematic diagram illustrating a driving-force transmission path along which the driving-force is transmitted from the motor M to the developing coupling 72 in a case where the clutch unit 120 is in a transmission state. FIG. 13B is a schematic diagram illustrating a driving-force transmission path along which the driving-force is transmitted from the motor M to the developing coupling 72 in a case where the clutch unit 120 is in a non-transmission state. FIG. 14A is a graph illustrating the torque applied to the developing coupling 72 in a comparative example. FIG. 14B is a graph illustrating the torque applied to the developing coupling 72 in the present embodiment.

As illustrated in FIG. 13A, in the present embodiment, the rotational drive of the motor M is transmitted to the developing coupling 72 via two paths: a first driving-force transmission path that passes through the first driving-force transmission unit 150, and a second driving-force transmission path that passes through the second driving-force transmission unit 250. More specifically, the first driving-force transmission path is a path along which the rotational drive output from the motor M is transmitted to the developing coupling 72 through the clutch unit 120, the development driving gear 111, and the like. The second driving-force transmission path is a path along which the rotational drive output from the motor M is transmitted to the developing coupling 72 through the drum-driving-force transmission unit 203, the drum coupling 63, the brake-force applying unit 260, the brake portion 206, the development driving gear 111, and the like.

The torque transmitted to the development driving gear 111 via the first driving-force transmission unit 150, not via the second driving-force transmission unit 250, that is, the torque transmitted to the developing coupling 72 through the first driving-force transmission path is referred to as a first torque TCL. In addition, the torque transmitted to the development driving gear 111 via the second driving-force transmission unit 250, that is, the torque transmitted to the developing coupling 72 through the above-described second driving-force transmission path is referred to as a second torque TB. The second torque TB is transmitted to the developing coupling 72 via the brake portion 206.

Furthermore, the torque necessary for driving the developing coupling 72 (i.e., the torque necessary for driving the developing unit 70) is referred to as a third torque TD. That is, the developing coupling 72 is driven when a torque equal to or higher than the third torque TD is applied to the developing coupling 72. The value of the second torque TB is determined by the performance of the brake portion 206 constituted by a torque limiter, and the value of the first torque TCL is determined by the performance of the motor M. In addition, the rotation speed of the outer ring 206a of the brake portion 206 is denoted by V1, and the rotation speed of the inner ring 206b of the brake portion 206 is denoted by V2.

As illustrated in FIG. 13A, in a case where the clutch unit 120 is in a transmission state, both of the first torque TCL and the second torque TB are transmitted to the development driving gear 111. In this case, the first torque TCL, the second torque TB, and the third torque TD satisfy the following equation.

$$TCL + TB \geq TD \qquad ( 1 )$$

That is, the total of the first torque TCL and the second torque TB is equal to or higher than the third torque TD, and the developing coupling 72 is driven by both of the first torque TCL and the second torque TB. Note that in the description of the present embodiment, the reduction gear ratio (increase gear ratio) between the development driving gear 111 and the developing coupling 72 is regarded as 1.

In addition, in the present embodiment, the speeds V1 and V2 satisfy the following expression.

$$V 1 > V 2 \qquad ( 2 )$$

Thus, the specifications of each gear of the driving-force transmission mechanism 200 is set so as to satisfy the above-described expression (2). Thus, the outer ring 206a of the brake portion 206 rotates at a speed higher than the speed of the inner ring 206b while receiving the brake force from the inner ring 206b. In other words, the rotation speed of the inner ring 206b is lower than the rotation speed of the outer ring 206a, and the inner ring 206b rotates at the speed V2 higher than 0. Thus, the inner ring 206b can apply the brake force to the drum unit 68, and thereby can stabilize the rotation of the drum unit 68.

In contrast, as illustrated in FIG. 13B, in a case where the clutch unit 120 is in a non-transmission state, only the second torque TB is applied to the development driving gear 111. In the present embodiment, the brake portion 206 constituted by a torque limiter is selected so that the second torque TB and the third torque TD satisfy the following expression.

$$TB < T D \qquad ( 3 )$$

That is, the second torque TB is lower than the third torque TD. Thus, in a state where the clutch unit 120 is in the non-transmission state, the second driving-force transmission unit 250 cannot drive the developing coupling 72. In addition, in this state, the inner ring 206b of the brake portion 206 stops together with the developing coupling 72 and the development driving gear 111, and the speed V2 of the inner ring 206b is zero. Also in this state, for satisfying the expression of V1 >V2, the outer ring 206a rotates at a speed higher than the speed of the inner ring 206b while receiving the brake force from the inner ring 206b. The drum coupling 63 is driven while the motor M is being driven regardless of whether the clutch unit 120 is in the transmission state or non-transmission state. Thus, the brake force can be applied to the drum unit 68, so that the rotation of the drum unit 68 can be stabilized.

In a comparative example illustrated in FIG. 14A, the above-described second driving-force transmission path is not formed, and the rotational drive is transmitted from the motor M to the developing coupling 72 via the first driving-force transmission path alone. That is, the developing coupling 72 is driven by the first torque TCL alone. In this case, if the state of the clutch unit 120 is switched from the transmission state to the non-transmission state, the torque applied to the developing coupling 72 is changed from the first torque TCL higher than the third torque TD necessary for driving the developing coupling 72, instantaneously to zero.

In contrast, in the present embodiment, the developing coupling 72 is driven by both of the first torque TCL and the second torque TB. That is, in the present embodiment, the first torque TCL can be made lower than the first torque TCL of the comparative example. In the present embodiment, as illustrated in FIG. 14B, if the state of the clutch unit 120 is switched from the transmission state to the non-transmission state, the torque applied to the developing coupling 72 is changed from the total of the first torque TCL and the second torque TB, to the second torque TB alone.

Thus, in the present embodiment, even if the state of the clutch unit 120 is switched to the non-transmission state, the second torque TB is applied to the developing coupling 72. As a result, the change in the torque caused when the state of the clutch unit 120 is switched from the transmission state to the non-transmission state can be reduced. Therefore, the impact caused when the state of the clutch unit 120 is switched from the transmission state to the non-transmission state can be reduced, so that the deformation of the clutch unit 120 can be prevented and the occurrence of noise from the clutch unit 120 can be reduced.

In addition, since the change in the torque (applied to the developing unit 70) caused when the state of the clutch unit 120 is switched from the transmission state to the non-transmission state can be reduced, the risk of deforming the frame of the cartridge P can be reduced. In addition, since the stiffness necessary for the frame of the cartridge P can be reduced, the cartridge P can be reduced in weight, and the amount of toner that can be stored in the cartridge P can be increased. In addition, since the second torque TB is constantly applied to the developing coupling 72 regardless of the state of the clutch unit 120, the position of the cartridge P can be stabilized, and the positional accuracy of the cartridge P can be increased.

### Other Embodiments

In addition, in the above-described embodiment, the development driving gear 111 to which the rotational drive is transmitted by the first driving-force transmission unit 150 and the second driving-force transmission unit 250 is a gear member. However, the present disclosure is not limited to this. For example, the present disclosure may be applied to another rotary member, instead of the development driving gear 111, that may be a pulley to which the driving-force is transmitted via a belt, or may be a member into which a gear portion and a pulley portion are combined with each other.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-155381, filed Sep. 9, 2024, which is hereby incorporated by reference herein in its entirety.

What is claimed is:

1. An image forming apparatus configured to form an image on a recording material, the image forming apparatus comprising:
a driving source;
a first driven member;
a second driven member different from the first driven member;
a first driving-force transmission unit configured to transmit driving force output from the driving source to the first driven member, the first driving-force transmission unit including a clutch mechanism configured to be switched between a transmission state and a non-transmission state, the transmission state being a state where the driving force output from the driving source is transmitted to the first driven member, the non-transmission state being a state where the driving force output from the driving source is not transmitted to the first driven member; and
a second driving-force transmission unit configured to transmit the driving force output from the driving source to the second driven member, and connected to the first driving-force transmission unit, the second driving-force transmission unit including a brake portion configured to produce brake force to apply load to rotation of the second driven member,
wherein the second driving-force transmission unit is connected to the first driving-force transmission unit between the clutch mechanism and the first driven member, and
wherein in a case where the clutch mechanism is in the transmission state, the first driven member is driven by both of a first torque transmitted via the first driving-force transmission unit, and a second torque transmitted via the brake portion of the second driving-force transmission unit.

2. The image forming apparatus according to claim 1, wherein the first driven member is configured to be driven in a case where a torque equal to or higher than a third torque is applied to the first driven member,
wherein a total of the first torque and the second torque is equal to or higher than the third torque, and
wherein the second torque is lower than the third torque.

3. The image forming apparatus according to claim 1, wherein the second driven member is driven while the driving source is being driven, regardless of whether the clutch mechanism is in the transmission state or the non-transmission state.

4. The image forming apparatus according to claim 1, wherein the first driven member is a developing coupling configured to drive a developing roller which is configured to bear toner.

5. The image forming apparatus according to claim 1, wherein the second driven member is a drum coupling configured to drive a photosensitive drum which is configured to bear a toner image.

6. The image forming apparatus according to claim 1, further comprising:
an apparatus body including the driving source, the first driving-force transmission unit, and the second driving-force transmission unit; and
a detachable unit including the first driven member and the second driven member, the detachable unit being configured to be detachably attached to the apparatus body.

7. The image forming apparatus according to claim 1, further comprising an actuator configured to switch state of the clutch mechanism between the transmission state and the non-transmission state.

8. The image forming apparatus according to claim 1, wherein the brake portion includes a torque limiter.

9. The image forming apparatus according to claim 1, wherein the first driving-force transmission unit includes a rotating body configured to rotate, the driving force output from the driving source being transmitted to the rotating body in a case where the clutch mechanism is in the transmission state, and not being transmitted to the rotating body in a case where the clutch mechanism is in the non-transmission state,
wherein the brake portion includes:
a first rotary member to which the driving force output from the driving source is transmitted; and
a second rotary member which is drivingly connected to the rotating body,
wherein the first rotary member is configured to rotate relative to the second rotary member while receiving the brake force, and
wherein the second rotary member rotates at a lower speed than the first rotary member in a case where the clutch mechanism is in the transmission state, and stops together with the first driven member and the rotating body in a case where the clutch mechanism is in the non-transmission state.

10. The image forming apparatus according to claim 1, wherein the second driving-force transmission unit includes a brake-force applying portion configured to apply the brake force to the second driven member.

11. The image forming apparatus according to claim 10, wherein the second driving-force transmission unit includes an engagement member configured to engage with the second driven member, and
wherein the brake-force applying portion includes a brake engagement member configured to engage with the second driven member.

12. The image forming apparatus according to claim 11, wherein the second driven member is configured to be rotated in a first rotational direction as driving force is transmitted to the second driven member via the second driving-force transmission unit,
wherein the engagement member is configured to engage with the second driven member in the first rotational direction, and
wherein the brake engagement member is configured to engage with the second driven member in a second rotational direction opposite to the first rotational direction.

13. The image forming apparatus according to claim 10, wherein the second driving-force transmission unit includes a driving-force transmission portion configured to transmit the driving force output from the driving source, to the second driven member, and
wherein the second torque is transmitted from the driving source to the second driven member via the driving-force transmission portion, the second driven member, the brake-force applying portion, and the brake portion.
